(19) United States
(12) Patent Application Publication
(10) Pub. No.: US 2026/0318053 A1
(43) Pub. Date: Oct. 15, 2026

(54) VALVE SHIELD SYSTEM

(71) Applicant: Raziel VARMAN, Modi'in (IL)

(72) Inventor: Raziel VARMAN, Modi'in (IL)

(21) Appl. No.: 19/681,635

(22) Filed: May 19, 2026

Related U.S. Application Data
(63) Continuation-in-part of application No. PCT/IB2024/061664, filed on Nov. 21, 2024.
(60) Provisional application No. 63/602,382, filed on Nov. 23, 2023.
(60) Provisional application No. 63/655,000, filed on Jun. 2, 2024.

(51) Int. Cl. E03B 9/06

(52) U.S. Cl. CPC E03B 9/06

(57) ABSTRACT

A valve shield system for preventing unauthorized access to a valve includes an outer shield and an access control mechanism (ACM) enclosed within the outer shield. The ACM has an adaptor assembly that can be fitted to an operating nut of the valve. The valve shield system also includes a manual key that can be inserted through an opening in the outer shield in order to interact with the ACM.

### TECHNICAL FIELD

Embodiments of the invention relate to a valve shield system, in particular for creating a secure enclosure around a region of a valve.

### BACKGROUND

A valve shield system is a protective device designed to fit over valves, such as fire hydrants, to prevent misuse, unauthorized access, and vandalism. These systems are often used in public infrastructure and are built to protect essential utilities from tampering while allowing access to authorized personnel when needed.

The shield typically forms a secure enclosure around the valve, and is constructed from durable materials like heavy-duty metals to withstand vandalism attempts, such as forced entry or damage from tools. Often, these systems include locks or specialized access mechanisms that only authorized personnel (like firefighters or maintenance workers) can operate, ensuring that the valve remains accessible for emergencies but protected from public tampering.

US2014373941 for example describes a protective-fire-hydrant-cover that includes an operating-nut-extender and a protective-fire-hydrant-casing. The operating-nut-extender is firmly coupled with an operating-nut of a fire-hydrant such that when the operating-nut-extender rotates, the operating-nut rotates therewith.

### SUMMARY

The following embodiments and aspects thereof are described and illustrated in conjunction with systems, tools and methods which are meant to be exemplary and illustrative, not limiting in scope.

In an embodiment there is provided a valve shield system for preventing unauthorized access to a valve, the valve shield system comprising an outer shield formed at least in part about an axis and an access control mechanism (ACM) substantially enclosed within the outer shield, the ACM comprising an adaptor assembly suitable for being fitted to an operating nut of the valve, wherein the valve shield system comprises a manual key for interacting with the ACM, possibly by being insertable through an opening in the outer shield.

In an embodiment there is provided a method for preventing unauthorized access to a valve comprising the steps of: providing valve shield system comprising an outer shield formed at least in part about an axis and an access control mechanism (ACM) substantially enclosed within the outer shield that comprises an adaptor assembly, fitting the adaptor assembly to an operating nut of the valve, and placing a manual key through an opening in the outer shield in order to interact with the ACM.

In an embodiment representing a possible independent aspect of the present disclosure, e.g. not necessarily related to the system's ACM, there is provided a system/method for sensing liquid flow through a valve that is protected against unauthorized access by a valve shield system, the systems/method comprises the steps of: providing valve shield system comprising an outer shield and an adaptor assembly, fitting the adaptor assembly to an operating nut of the valve, and positioning a microphone in proximity to the operating nut of the valve.

In an embodiment representing another possible independent aspect of the present disclosure, e.g. not necessarily related to the system's ACM, there is provided a system/method for transmitting signals out of a valve shield system that prevents unauthorized access to a valve, the system/method comprises the steps of: providing valve shield system comprising an outer shield, fitting the valve shield system to the valve so that the outer shield substantially prevents access to the valve, and positioning an antenna in association with the outer shield.

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIG. 1 schematically shows a valve shield system in accordance with various embodiments of the present invention, shown mounted to a valve;

FIGS. 2A and 2B schematically show, respectively, an operating nut at an upper side of a valve and an adaptor assembly of an embodiment of a valve shield system being fitted to the operating nut;

FIGS. 3A, 3B, 4A, 4B, 5A and 5B schematically show cross sectional views of various valve shield system embodiments during various operating states;

FIGS. 6A to 6C schematically show an upper side of an embodiment of a valve shield system revealing an antenna that can be integrated into said upper side;

FIG. 7 schematically shows an exploded view of a valve shield system in accordance with an embodiment of the present invention;

FIGS. 8 and 9 schematically show views of a valve shield system in accordance with yet other embodiments of the present invention; and

FIGS. 10A and 10D schematically show cross sectional views of a valve shield system embodiment during various operating states, while FIGS. 10B and 10C are enlarge sections of FIG. 10A.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

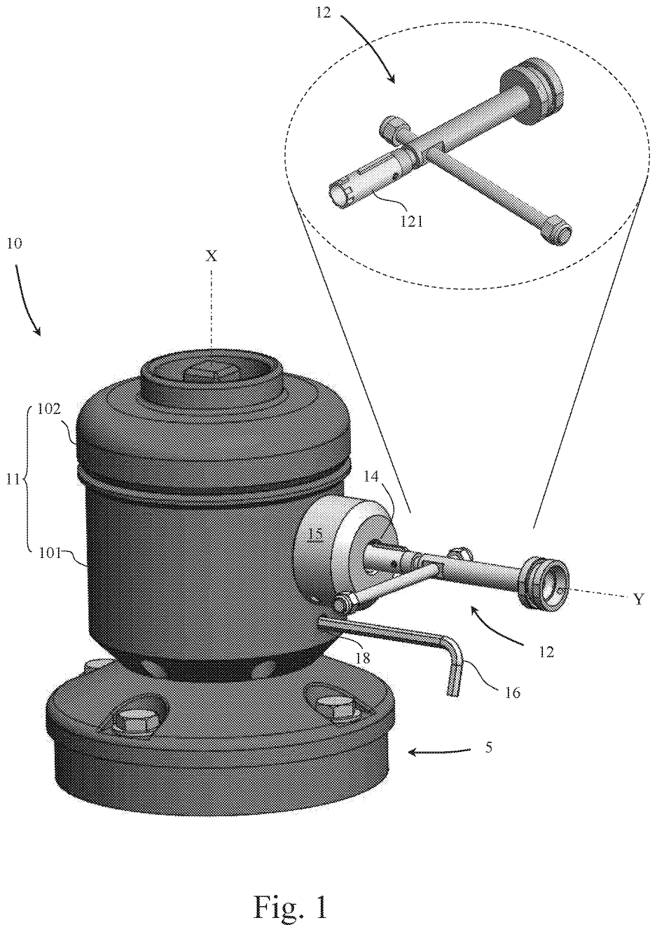

Attention is first drawn to FIG. 1 schematically showing a valve 5 and a valve shield system 10 in accordance with various embodiments of the present invention that is mounted to the valve 5.

The valve 5 may be of various types, such as a hydrant by which fire fighters can tap into a water supply, a general valve used e.g. in agricultural irrigation systems, a valve used within a supply pipeline of a municipal network (or the like).

The valve shield system 10 has an outer shield 11 that in this optional example includes a peripheral outer casing 101 and a top 102 that is secured to an upper axial side of the outer casing 101. A cover 15 including a key opening 14 provides an “entry” through the outer shield's casing 101 in this example along an axis Y that is transverse or possibly generally perpendicular to an upright central axis X of the valve (and hence to a combined assembly of the valve 5 and the valve shield system 10).

This “entry” through the key opening 14 is towards an access control mechanism (ACM) that is substantially enclosed, housed and/or concealed within the system's outer shield 11. Certain elements of the ACM discussed below, such as a bolt system 30 and key way 28, although not fully enclosed within the outer shield 11 are to be considered as fulfilling such “enclosure” due to elements upon the system's outer periphery, such as cover 15, that provide such “enclosure”. Embodiments of such an access control mechanism (ACM) will be described in more detail herein below.

A key 12 for permitting access towards certain elements of the ACM and hence for operating the valve shield system 10 is shown located through the key opening 14, and is also shown in isolation in the enlarged section at the upper side of this figure. The key 12 acts as one option of an “activating mechanism” for activating in this example manually the ACM.

The key 12 may be arranged to have various types of key bittings 121 with various combinations of key cuts. Certain key bittings 121 may be designed as master key bittings that can activate several valve shield systems, while certain other non-master key bittings 121 can be designed to be more limited in function, e.g. to activate a few or possibly only one specific valve shield system.

Also seen in FIG. 1 is a bolt driver in this example shown as a hex key 16 that is fitted through an aperture 18 formed in the outer shield's casing 101 of the valve shield system 10. Aperture 18 also provide access towards certain elements of the access control mechanism (ACM). The hex key 16 can be used for assembly and disassembly of a valve shield system 10 to the valve 5 as will be explained in more detail below.

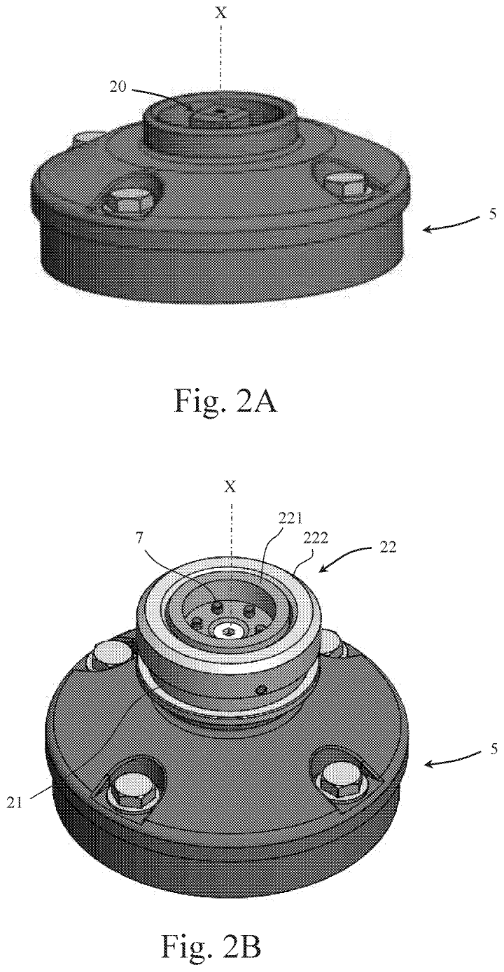

Attention is drawn to FIGS. 2A and 2B schematically showing, respectively, an operating nut 20 at an upper axial side of the valve 5 and an adaptor assembly 22 of a valve shield system embodiment, which is fitted to the operating nut. The adaptor assembly 22 belongs to the access control mechanism (ACM) of the shield system. The operating nut 20 may be of various types and shapes, such as square shaped as here seen, pentagon shaped (or the like).

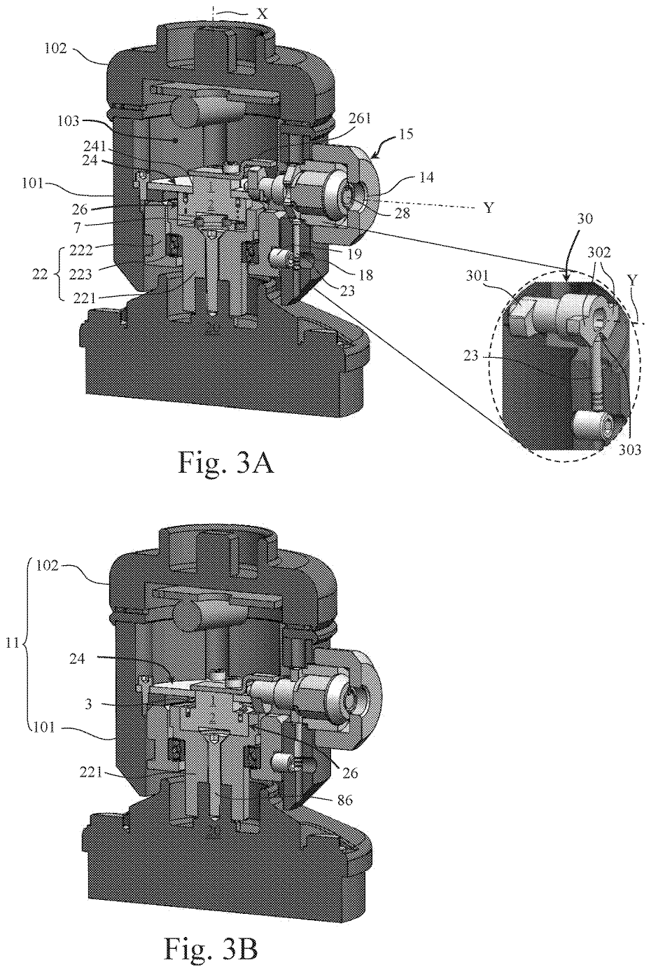

Attention is additionally drawn to FIGS. 3A and 3B showing cross sectional views taken along the central axis X of the valve and valve shield system, revealing interior elements of the access control mechanism (ACM) in accordance with an embodiment of the present disclosure.

The ACM's adaptor assembly 22 as seen includes a core 221 that is secured in this example by a screw 86 to a threaded bore formed in the valve's operating nut 20.

It is noted that other elements for securing the core 221 to a valve's operating nut 20 may also be possible and may depend e.g. on the type of operating nut (or other equivalent means for operating the valve) that may exist in the valve to which the valve shield system is being fitted. For example, securing the core to a valve's operating nut may be accomplished by pins or any other coupling elements suitable for coupling between two such objects.

In some cases, an element used for securing the core to the operating nut may not necessarily do so along axis X. For example, such element(s) may extend through the core 221 in order to engage with the valve's operating nut along an axis that is inclined to axis X and optionally generally orthogonal to axis X.

The ACM's adaptor assembly 22 further includes an outer ring 222 that is located about the core 221 and a peripheral bearing 223 that is located between the outer ring 222 and the core 221.

The outer shield 11 of the valve shield system encloses an interior hollow chamber 103 where elements of the ACM are located, and a connecting screw 19 threaded through aperture 18 can be used to secure the outer shield's casing 101 to a depression 21 (see depression 21 indicated in FIG. 2B) that is formed upon the outer periphery of the outer ring 222.

Securing the outer shield 11 to the outer ring 222 results in the outer shield being arranged to rotate about the outer ring 222 and about axis X while limiting the shield's ability to be lifted axially upwards to reveal the ACM due to the screw 19 being placed within depression 21. In certain cases, the screw 19 may be urged to press against an inner side of the depression 21 thus substantially fixing the outer ring 222 to rotate together with the outer shield. Top 102, which is secured to the upper side of casing 101—is accordingly also secured to rotate together with casing 101 about axis X.

An upper side of the core 221 in this example is generally cup shaped and includes several engagement members 7 here optionally formed as bulge members, within the cup shaped formation. The core's cup shaped formation opens upwards into an upper side of chamber 103.

In the following, further elements belonging to the access control mechanism (ACM) will be describe, such as: seat 24 hub 26, lever 261, bolt system 30, (etc.).

A seat 24, in this example formed as a plate, can be seen being located above the core 221 within chamber 103. The seat 24 is secured to casing 101 and here can be seen including a central keyed cutout 241 optionally formed in this example to be generally rectangular.

The valve shield system may include a hub 26 that has upper 1 and lower 2 segments. The hub's upper segment 1 has a cross sectional periphery that generally matches the unique shape of the keyed cutout 241.

The hub 26 is axially movable along axis X through interaction between its upper segment 1 and the keyed cutout 241, while the hub's second segment 2 is wider than the upper segment 1 and remains below the seat 24. A lever 261 can here be seen being attached to an axial upper side of the hub's upper segment 1.

A key way 28 located within the cover 15 may be coupled to a bolt system 30 that may be operated to rotate by the key 12 about axis Y. The bolt system 30, as best seen in the enlarged section at the right-hand side of FIG. 3A, may include in this example a major bolt 301 and a pair of secondary bolt wings 302.

The major bolt 301 is located more inwards along axis Y towards the interior of the outer shield with respect to the pair of secondary bolt wings 302. A depression 303 opening radially outwards away from axis Y may be formed in between the bolt wings 302.

In this example, the major bolt 301 projects radially outwards away from axis Y along a trajectory that is generally parallel to one of the bolt wings 302. The major bolt 301 as seen is also positioned beneath lever 261.

As seen in FIG. 3A, the key 12 may be used to rotate the bolt system about axis Y to position its major bolt 301 to protrude generally axially upwards along axis X. This position of the major bolt 301 as seen is adapted to lift the hub 26 axially upwards along axis X to disengage from the core's engagement members 7.

Rotating the bolt system about axis Y away from the position seen in FIG. 3A, to position its major bolt 301 to protrude e.g. generally downwards along axis X as seen in FIG. 3B—is adapted to allow the hub 26 to move axially downwards along axis X.

This downward movement of the hub 26 can occur until corresponding engaging elements (not seen) formed in the lower side of its second segment 2, engage the engagement members 7 of the core 221. A spring 3 placed in between the seat 24 and hub 26 may assist in urging the hub 26 towards the core 221 in order to engage and mesh with the core.

In the disengaged state of the valve shield system 10 from the valve 5, which is seen in FIG. 3A, rotation of the outer shield 11 (i.e., casing 101 and top 102) about axis X will not be transmitted via the ACM to the operating nut 20 of the valve 5. In other words, in this disengaged state the valve shield system 10 cannot be used to open or close the valve 5.

On the other hand, in the engaged state of the valve shield system 10 with the valve 5, which is seen in FIG. 3B, rotation of the outer shield 11 (i.e., casing 101 and top 102) about axis X will be transmitted via the ACM to the operating nut 20 of the valve 5 through engagement between the ACM's elements of the hub 26 and core 221.

In other words, the ACM's seat 24 that is fixed to the outer casing 101 transmits via interaction between its keyed cutout 241 and the hub's upper segment 1, rotational motion to the engaged core 221. As a result, in this engaged state the valve shield system 10 can be used to open or close the valve 5.

With attention drawn back to FIG. 3A, it is seen that a securing bolt 23 can be used to conceal access through aperture 18 to connecting screw 19 in order to avoid unintentional removal of the valve shield system 10 from the valve 5 by un-authorized personal.

Rotating the key 12 to position one of its bolt wings 302 projecting generally downwards as seen in the cross section at the left hand side of this figure-is adapted to make sure that the securing bolt 23 cannot be lifted upwards to permit access by a bolt driver such as hex key 16 towards connecting screw 19.

Rotating the key 12, as seen in the enlarged section at the right-hand side of this figure, to position the depression 303 above the securing bolt 23, will allow the securing bolt 23 to be lifted upwards to permit access by a bolt driver such as hex key 16 towards connecting screw 19.

In this way, authorized personal having a key 12 (e.g. a master key) suitable for operating the discussed valve shield system 10, can e.g. remove the casing 101 and top 102 to perform maintenance or the like to the valve shield system 10 and its ACM.

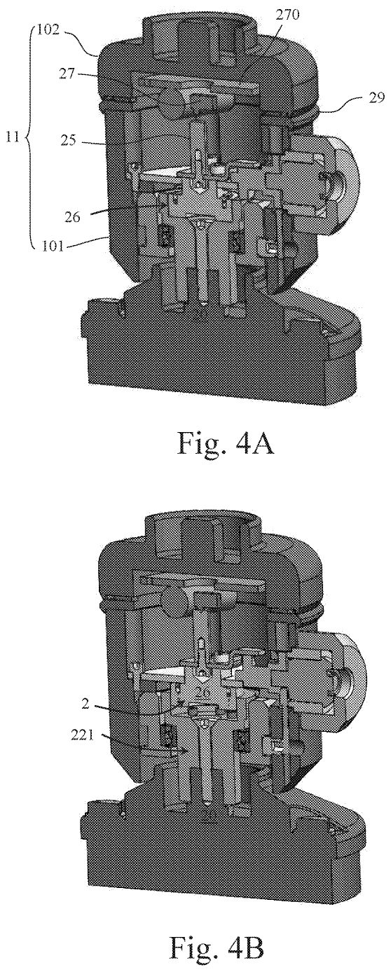

Attention is drawn to FIGS. 4A and 4B showing a valve shield system 10 generally similar to the one discussed in FIGS. 3A and 3B, however here being fitted with an optional rod 25 that projects upwards along axis X away from the hub 26.

This embodiment of the valve shield system 10 in particular includes also a micro switch 27 that is located above rod 25 here mounted to an axial lower side of the top 102. The micro switch 27 communicates with a circuit board 270 of the system, which in this example is also attached to top 102. It is noted that instead of a rod any other means may be used to provide the interaction with the micro switch that will be discussed here below.

In this embodiment, urging the hub 26 to lift upwards as seen in FIG. 4B to disengage the hub's lower segment 2 from the core 221 and by that from valve's operating nut 20, is adapted to urge the rod 25 to engage the micro switch 27. Accordingly, in this example, the micro-switch 27, when pressed, detects a disengaged state of the valve system, in which rotation of the outer shield does not result in opening or closing of the operating nut of the valve.

Lowering the hub 26 downwards to engage at its lower segment 2 with the core 221 and by that with the valve's operating nut 20—is adapted to urge the rod 25 to disengage from the micro switch 27. Accordingly, in this example, the micro-switch 27, when released from pressure, detects an engaged state of the valve system, in which rotation of the outer shield results in opening or closing of the operating nut of the valve.

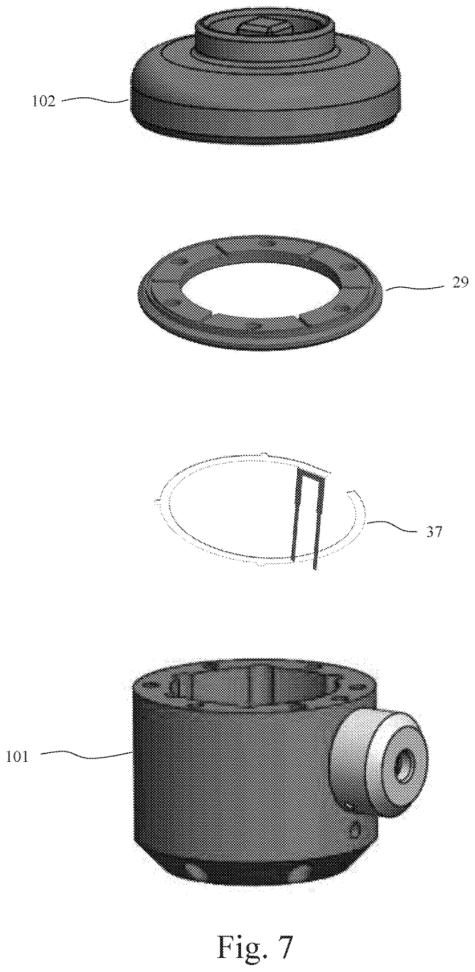

As a result, an indication on the state of the valve shield system 10 can be provided via the micro switch 27. This indication may be transmitted outwards via the circuit board 270 from the valve shield system 10, e.g. by an antenna (see e.g. antenna 37 in FIG. 7) that may be housed within an antenna housing 29, which in this example of FIG. 7 may be seen being fitted in-between casing 101 and top 102.

In certain embodiments, a rotation-detecting sensor or rotation sensing device may be disposed within the valve shield system and configured to detect rotational movement of the system's outer shield. In certain embodiments, the rotation-detecting sensor may comprise, by way of non-limiting example, a gyroscope sensor. Such rotation-detecting sensor may be positioned in some cases on circuit board 270.

In cases where an engaged state of the valve shield system is detected, for example by the micro-switch 27, correlating this information with detected rotation of the outer shield may provide information indicative of the extent to which a valve associated with the valve shield system has been opened or closed.

In certain cases, detection of such opening or closing of the valve may further allow estimation or determination of an actual flow rate or consumption of water released through the valve, which may be transmitted out of the valve system through its 37. Typically, the outer shield 11 (i.e. the outer casing 101 and top 102) of the shield system are made from metallic material such iron, stainless steel or a casting of mixed metallic material. Such materials act as radio-frequency (RF) shielding materials that prevent or substantially reduce the transmission or reception of radio frequency signals.

The antenna housing 29, which is typically made from a material that is transparent or permeable to radio frequency (RF) signals (such as plastic or polymer material)-when placed at a location along the outer housing of the shield system provides a so called “gap” through which such transmissions may occur.

Therefore, embedding/associating an antenna (such as antenna 37) within such an antenna housing 29 provides an ability to permit transmission or reception of radio frequency signals out of and/or into the shield system. It is noted that the antenna may take various forms, such as a coiled wire (or the like).

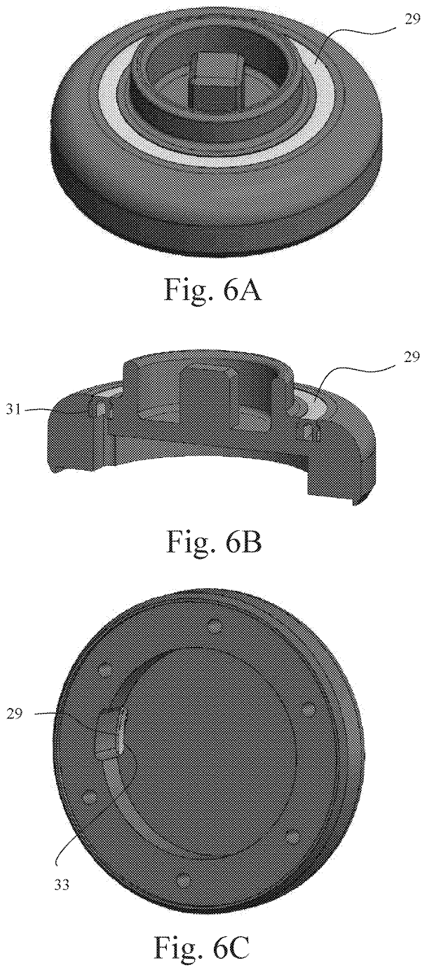

As seen in FIG. 6A to 6C, an antenna housing 29 may also be placed in other locations in the valve shield system 10 such as in the top 102. Here a peripheral groove 31 may be formed in the exposed upper outer side of the top 102 and the antenna housing 29 may be snap fitted in this example into the groove.

A slit 33 (see FIG. 6C) formed at a lower side of the top 102 through which the groove 31 can open into chamber 103—may assist in communicating signals to be transmitted by the antenna outwards from the valve shield system 10, such as signals originating from the micro switch 27.

Attention is drawn to FIG. 7 showing an exploded view of valve shield system 10 generally similar to the one seen in FIGS. 1 to 5. Here, the antenna 37 with its antenna housing 29 (that is made from materials that are transparent or permeable to radio frequency (RF) signals) can be seen being sandwiched in between the outer casing 101 and top 102 of the shield system (which are typically made from shielding materials that prevent or substantially reduce the transmission or reception of radio frequency signals).

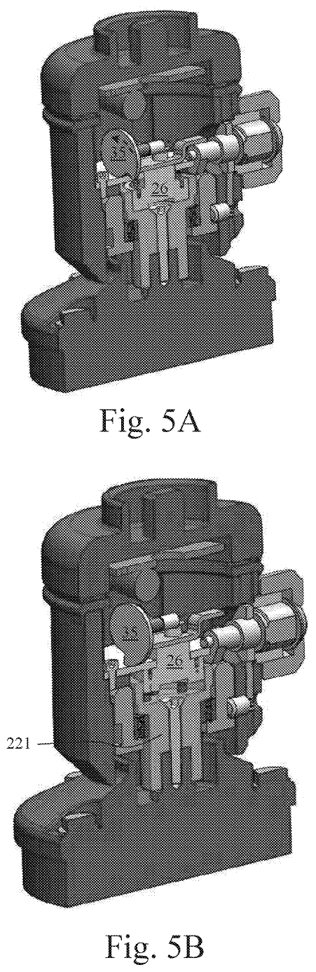

Attention is drawn to FIGS. 5A and 5B demonstrating another “activating mechanism” that may be used in certain embodiments for activating the ACM in order to transition a valve shield system 10 between disengaged and engaged states. This other example of an “activating mechanism” may be in addition or instead of the above discussed use of the “activating mechanism” embodied as a key 12 for controlling such transitions.

Here, a spiraling disc 35 with a gradually expanding circumference may be fitted to an axially upper side of the seat 24 to function as an “activating mechanism” for the ACM. The spiraling disc 35 may be controlled to rotate in a first rotational direction (see indicated by the ‘dashed’ arrow in FIG. 5A) e.g. by an electrical motor located within chamber 103 of the valve shield system 10 in order to urge hub 26 to lift upwards and by that disengage from core 221 (see FIG. 5B) or move downwards and by that engage with the core 221 (see FIG. 5A).

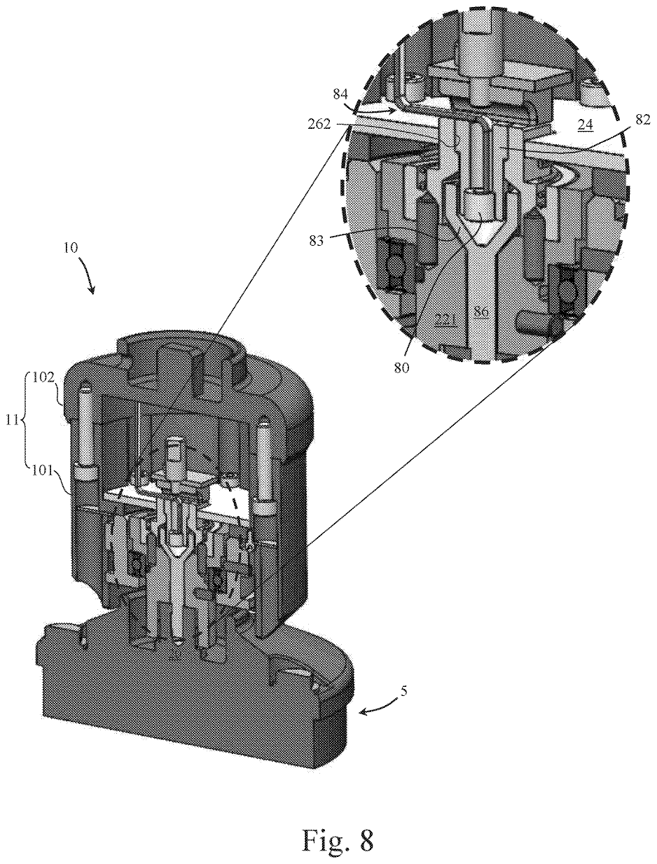

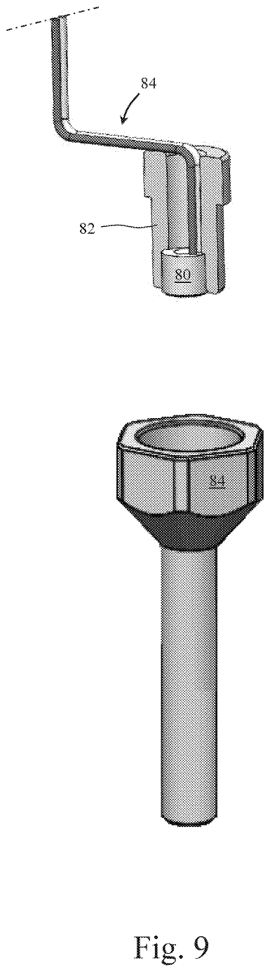

Attention is drawn to FIGS. 8 and 9 schematically showing an embodiment of a valve shield system 10 equipped with a microphone 80 in order to acoustically sense liquid flow passing through a valve it is connected to. The acoustic sensing may relate to liquid flowing outward from the valve or to a reverse flow of liquid entering the valve. Detection of such reverse flow or outward flow may be facilitated by analysis of an acoustic profile sensed by the microphone. Information related to such reverse or outward flows may be transmitted out of the valve shield system.

Transmission of the detection of such outward flow by the acoustic sensor may indicate a potential valve leak if, for example, a rotation-detecting sensor associated with the system does not detect rotation of the system's outer shield. Conversely, if the rotation-detecting sensor associated with the system detects rotation of the system's outer shield while the acoustic sensor does not detect such a flow, this may indicate a malfunction of the valve to which the valve shield system is attached, for example due to a lack of liquid pressure in the pipes supplying the valve.

The microphone 80 as seen is fitted in this example within a sleeve 82, possibly glued to the sleeve. In these figures the sleeve is shown in cross section to reveal the microphone.

The sleeve 82 at its upper side is secured to rotatably move together with the seat 24 and casing 101, and the sleeve extends downwards from there through a passage 262 formed within the hub 26 to position the microphone 80 within a cup shaped funnel 83 here optionally belonging to a screw 86 that is used for securing the core 221 to the operating nut 20.

Electrical wires 84 can here be seen extending upwards from the microphone 80 through sleeve 82 to electrically submit away from the microphone electrical signals indicative of sound that it picks up adjacent the screw within its funnel 83. The electrical wires 84 extend upwards towards a circuit board located within the shield, such as circuit board 270 seen and indicated in FIG. 4A.

Securing the microphone 80 to rotate together with the circuit board during operation of the valve shield system, assists to enable electrical communication between the microphone and the circuit board, here implemented by the electrical wires 84.

In other words, if the microphone 80 would not be fixed to rotate together with the outer casing 101 and the circuit board 270 that is connected in this example to its top 102, such electrical wires could not be easily used for communicating between the microphone 80 and circuit board 270 since they would be twisted and possibly tear above a certain degree of rotation of the outer casing 101.

Positioning the microphone 80 within funnel 83 (that may also be referred in a broader context as a ‘noise guard’) is aimed at concealing at least partially the microphone from noise from its surrounding, so that the noise picked up from the microphone will be aimed substantially in this example downwards towards the valve via the screw 86 that engages the valve.

In tests that were performed, positioning the microphone adjacent to the screw 86, which engages the valve's operating nut 20, assists in obtaining signals by the microphone that are indicative of liquid flowing into or out of the valve 5.

Thus, in a broad aspect of the present invention, there is provided a method of placing an ‘sensor’ (here microphone 80) at a location (here within shield system 10) that is relatively distally displaced apart and independently movable (here fixed to rotate with casing 101) with respect to a ‘device’ (here valve 5) that regulates, directs, or controls a flow of a liquid-whereby this method includes placing the ‘sensor’ adjacent a ‘bridging member’ (here screw 86) that engages a ‘part’ (here operating nut 20) of the ‘device’ in order to acoustically sense vibrations that propagate through the ‘bridging member’, which are indicative of liquid flow at the ‘device’.

These signals can then be transmitted out of the valve shield system e.g. by an antenna 29 belonging to the system.

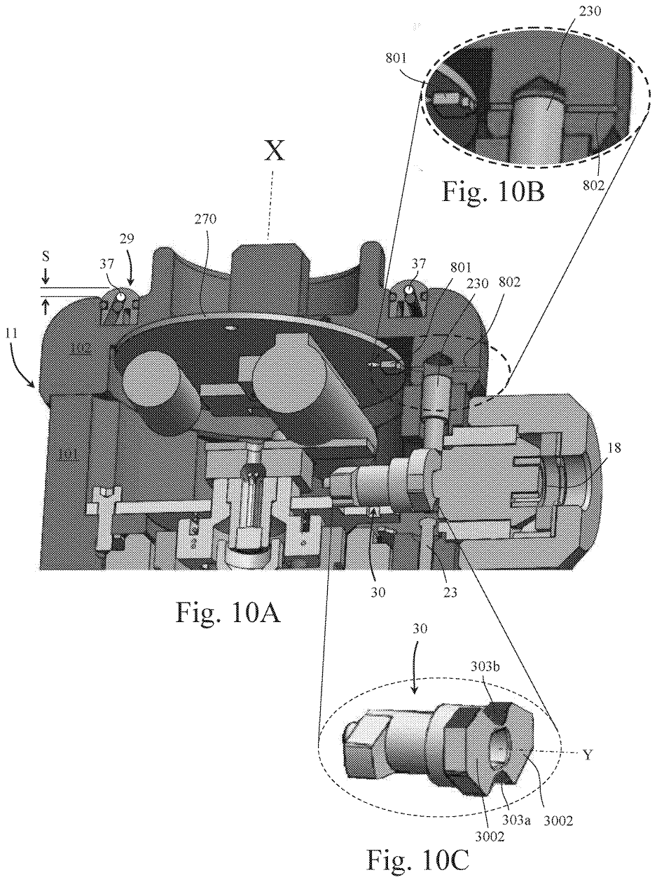

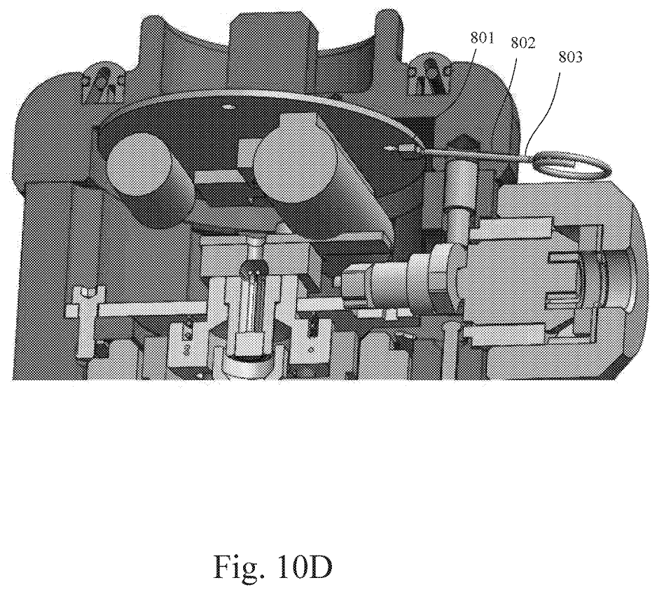

Reference is now made to FIGS. 10A-10D, which illustrate an embodiment of a valve shield system generally similar to the valve system described, for example, with reference to FIGS. 3A and 3B and 4A and 4B. This illustrated valve system embodiment exemplifies the provision of a tool-actuated recessed control actuator 801, possibly positioned on a circuit board 270 of the valve system. The control actuator 801 is accessible through a pin-hole bore 802 formed in an outer shield 11 of the valve.

In FIG. 10D, a pin-like tool 803 is illustrated being inserted through the pin-hole bore 802 to actuate the control actuator 801. Actuation of the control actuator 801 may enable without opening the valve shield system the following exemplary outcomes: reset, initiation of operation or shutdown of the valve system, execution of software and communication reset operations in the field (and the like).

Similar to securing bolt 23 seen e.g. in FIG. 3A, in this embodiment an additional securing bolt 230 may be used to conceal access through pin-hole bore 802 towards the control actuator 801 to avoid un-authorized access by un-authorized personal.

As seen in the enlarged section of FIG. 10C, the bolt system 30 in this example may be configured to have a pair of secondary bolt wings 3002 that include a pair of depressions 303a and 303b opening radially outwards away from its axis Y in opposing directions.

A first one of the depressions 303a, similar to the depression 303 shown in the enlarged section of FIG. 3A—is positioned above the securing bolt 23 to control access as previously discussed towards connecting screw 19. The second depression 303b is positioned below securing bolt 230 to control access towards the control actuator 801.

Rotation of a key (not shown) inserted into the key-way 18 by approximately ninety degrees from the position of the bolt system 30 shown in FIG. 10A is configured to urge the securing bolt 230, via one of its bolt wings 3002, upwards alongside axis X into a position in which access through the pin-hole bore 802 is concealed. The enlarged view of FIG. 10B illustrates this condition, in which the securing bolt 230 has been urged upward as a result of rotation of the key. Simultaneously, the other bolt wing 3002 in this example is configured to press downward against the securing bolt 23, thereby concealing access to the connecting screw 19.

The valve system embodiment illustrated in FIG. 10 further demonstrates an independent inventive aspect relating to the antenna housing 29 of the valve system. In this example, similarly to the antenna housing 29 shown in FIG. 6, the antenna housing 29 is positioned at a top portion 102 of an outer shield 11.

In order to improve radio-frequency signal transmission, an outer, in this example upper, portion of the antenna housing 29 is configured to protrude above the top 102 of the outer shield, as indicated by a protrusion distance S indicated in FIG. 10A.

This configuration is intended to reduce potential shielding effects caused, in certain cases, by radio-frequency (RF) shielding materials of the outer shield, thereby improving reception and transmission of signals to and from the valve shield system. The antenna 37, as indicated in FIG. 10A, may extend through portions of the antenna housing 29 that protrude above the outer side of the outer shield 11.

By way of a summary, operation of the valve shield system embodiments disclosed herein may be summarized as following.

In an initial operation, a valve shield system may be defined as being mechanically coupled to a valve/hydrant. Upon coupling, a key may be used to rotate a bolt system 30 of the system, e.g. approximately a quarter turn, and control actuator 801 may then be actuated in order to operatively connect and establish communication of the valve shield system with an operator communication network.

Following connection, the valve may be operated as follows. Rotation of the key, e.g. by approximately one hundred eighty degrees, to a disengaged state of the valve system results in the generation of a corresponding status indication within the system e.g. by micro-switch 27.

Rotation of the key to assume an engaged state of the valve shield system results in the generation of a corresponding status indication within the system e.g. by micro-switch 27.

Signals produced by a rotation-detecting sensor as the valve's outer shield 11 rotates in the system's engaged state may be counted to derive information representative of the water flow rate through the valve controlled and protected by the valve shield system.

Upon commencement of water flow, a flow indication may be generated by an acoustic sensor, the indication possibly being cross-correlated with data obtained from a rotation-detecting sensor.

In cases where a liquid is introduced into the water system in a reverse direction, a dedicated reverse-flow indication may be generated based on output of the acoustic sensor.

Closure of the hydrant valve may result in a corresponding indication generated by the rotation-detecting sensor. Cessation of forward flow or cessation of reverse flow may be detected by the acoustic sensor, which provides a corresponding flow-termination indication.

Locking the valve shield system using the key results in a disengaged state that may generate a locked-state status indication within the system.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Further more, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures can not be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

1. A valve shield system for preventing unauthorized access to a valve,
the valve shield system comprising an outer shield formed at least in part about an axis X and an access control mechanism (ACM) substantially enclosed within the outer shield,
the ACM comprising an adaptor assembly, and the adaptor assembly comprising a core suitable for being fitted to an operating nut of the valve and a hub that is axially movable within the outer shield, wherein
the valve shield system comprises an activating mechanism for interacting with the ACM in order to create mechanically actuated movements within the ACM that comprise direct physical contact, wherein
the activating mechanism comprises a key and the hub is mechanically actuated to be axially movable within the outer shield in response to interaction of the key with the ACM, wherein
the ACM comprises a bolt system and interaction of the key with the ACM comprises rotating the bolt system, and rotating the bolt system is configured to axially move the hub.

2. The valve shield system of claim 1, wherein the adaptor assembly comprises an outer ring rotatable about the core.

3. The valve shield system of claim 2, wherein the outer ring is secured to the outer shield at least in an axial direction along axis X.

4. The valve shield system of claim 1, wherein the hub is configured to engage and disengage with the core in response to opposing axial movements, wherein engaging with the core comprises axially moving the hub downwards to be in meshing engagement with at least a portion of the core.

5. The valve shield system of claim 1, wherein the activating mechanism comprises an electro mechanical device and the hub is mechanically actuated to be axially movable within the outer shield in response to interaction of the electro mechanical device with the ACM.

6. The valve shield system of claim 4 and comprising a seat axially spaced apart from the core, the seat being fixed to the outer shield and comprising a keyed cutout through which the hub is axially movable.

7. The valve shield system of claim 6, wherein a segment of the hub moving through the keyed cutout comprises a cross sectional periphery that generally matches a shape of the keyed cutout.

8. The valve shield system of claim 7, wherein the shape of the keyed cutout is non-circular, for example generally rectangular.

9. The valve shield system of claim 5 and comprising a micro switch positioned within the outer shield to detect signals that indicate movement of the hub.

10. The valve shield system of claim 1 and comprising a microphone positioned within the outer shield to detect signals associated with liquid flow through a valve to which the valve shield system is attached.

11. A valve shield system for preventing unauthorized access to a valve,
the valve shield system comprising an outer shield formed at least in part about an axis X and an access control mechanism (ACM) substantially enclosed within the outer shield,
the ACM comprising an adaptor assembly, and the adaptor assembly comprising a core suitable for being fitted to an operating nut of the valve and a hub that is axially movable within the outer shield, wherein
the valve shield system comprises an activating mechanism for interacting with the ACM in order to create mechanically actuated movements within the ACM that comprise direct physical contact, wherein
the activating mechanism comprises an electro mechanical device and the hub is mechanically actuated to be axially movable within the outer shield in response to interaction of the electro mechanical device with the ACM.

12. The valve shield system of claim 11, wherein the adaptor assembly comprises an outer ring rotatable about the core.

13. The valve shield system of claim 12, wherein the outer ring is secured to the outer shield at least in an axial direction along axis X.

14. The valve shield system of claim 11, wherein the hub is configured to engage and disengage with the core in response to opposing axial movements, wherein engaging with the core comprises axially moving the hub downwards to be in meshing engagement with at least a portion of the core.

15. The valve shield system of claim 11, wherein the activating mechanism comprises an electro mechanical device and the hub is mechanically actuated to be axially movable within the outer shield in response to interaction of the electro mechanical device with the ACM.

16. The valve shield system of claim 14 and comprising a seat axially spaced apart from the core, the seat being fixed to the outer shield and comprising a keyed cutout through which the hub is axially movable.

17. The valve shield system of claim 16, wherein a segment of the hub moving through the keyed cutout comprises a cross sectional periphery that generally matches a shape of the keyed cutout.

18. The valve shield system of claim 17, wherein the shape of the keyed cutout is non-circular, for example generally rectangular.

19. The valve shield system of claim 15 and comprising a micro switch positioned within the outer shield to detect signals that indicate movement of the hub.

20. The valve shield system of claim 11 and comprising a microphone positioned within the outer shield to detect signals associated with liquid flow through a valve to which the valve shield system is attached.
